(19) United States
(12) Patent Application Publication
(10) Pub. No.: US 2005/0008332 A1
(43) Pub. Date: Jan. 13, 2005

(54) Apparatus and method for controlling image information reproducing apparatuses

(75) Inventors: Takahiko Ogikubo, Tokorozawa-City (JP); Satoshi Koizumi, Tokorozawa-City (JP); Katsumi Kimura, Tokorozawa-City (JP)

Correspondence Address: SUGHRUE MION, PLLC, 2100 Pennsylvania Avenue, NW, Washington, DC, 20037-3213, US

(73) Assignee: PIONEER CORPORATION

(21) Appl. No.: 10/855,947

(22) Filed: May 28, 2004

(30) Foreign Application Priority Data
Jun. 3, 2003 (JP) 2003-157607

(51) Int. Cl. H04N 5/783

(52) U.S. Cl. 386/69; 386/70

(57) ABSTRACT

An apparatus and method for controlling a plurality of image information reproducing apparatuses are provided for ensuring that an arbitrary one is selected from among the image information reproducing apparatuses as a target for an operation control. A plurality of reproduced images based on image data reproduced from respective image information reproducing apparatuses are displayed simultaneously on a display screen. The operation control is directed only to an image information reproducing apparatus corresponding to a reproduced image arbitrarily selected from these reproduced images.

### BACKGROUND OF THE INVENTION

1. Field of the Invention

The present invention relates to an apparatus and method for controlling the operation of a plurality of image information reproducing apparatuses

2. Description of the Related Art

At present, there has appeared on the market a product which has a plurality of information recording/reproducing apparatuses, such as a DVD recorder, a hard disk recorder and the like contained in a single housing (see, for example, Japanese Patent Application Kokai No. 2001-236715).

Such a product can simultaneously and independently set each of the DVD recorder and hard disk recorder to a recording or a reproducing operation. For example, just in the middle of reproducing a video image by the DVD recorder, contents recorded in the hard disk recorder can also be reproduced simultaneously. In this event, the image reproduced from the DVD recorder is displayed in a left-half region of a display screen, while the image reproduced from the hard disk recorder is displayed in a right-half region of the display screen, respectively.

For changing a variety of recording/reproducing operations (reproduction, stop, fast forward, rewind, record, and the like) of the hard disk recorder, the user first depresses a HARD DISK RECORDER button provided on a remote controller, and subsequently depresses a button for specifying a particular recording or reproducing operation. Likewise, for changing a variety of recording/reproducing operation (reproduction, stop, fast forward, rewind, record, and the like) of the DVD recorder, the user first depresses a DVD RECORDER button provided on the remote control, and subsequently depresses a button for specifying a particular recording or reproducing operation in a manner similar to the foregoing.

In this event, the user views an image displayed on the display screen to change a variety of recording/reproducing operations (reproduction, stop, fast forwarding, rewind, record, and the like) as mentioned above.

Thus, the user is likely to change an unintended operation unless the user recognizes that an image reproduced from a DVD is being displayed in the left-half region of the display screen and an image reproduced from the hard disk is being reproduced in the right-half region of the display screen.

### SUMMARY OF THE INVENTION

The present invention has been made to solve the problem as mentioned above, and it is an object of the invention to provide an apparatus and method for controlling image information reproducing apparatuses, which is capable of ensuring that the user is allowed to operate arbitrary one of the plurality of image information reproducing apparatuses.

The present invention provides a control apparatus for controlling a plurality of image information reproducing apparatuses in parallel. The control apparatus includes display controller for simultaneously displaying a plurality of reproduced images on a display screen in accordance with image data produced from each of the image information reproducing apparatuses, and an operation unit for alternatively selecting an operation control common to the image information reproducing apparatuses, wherein the operation unit selects one of the image information reproducing apparatuses corresponding to a reproduced image arbitrarily selected from the reproduced images displayed on the display screen.

The present invention also provides a control method for controlling a plurality of image information reproducing apparatuses by using an operation unit for alternatively performing an operation control common to the image information reproducing apparatuses. The method includes the steps of displaying a plurality of reproduced images simultaneously on a display screen in accordance with image data reproduced from each of the image information reproducing apparatuses, and selecting only one of the image information reproducing apparatuses corresponding to a reproduced image arbitrarily selected from the reproduced images displayed on the display screen as a target for the operation control by using the operation unit.

### BRIEF DESCRIPTION OF THE DRAWINGS

FIG. 1 is a diagram showing the configuration of a recording system which is equipped with an apparatus for controlling image information reproducing apparatuses according to the present invention;

FIG. 2 is a diagram showing screen regions ER and EL defined in a display screen 10a of a display device 10 for simultaneously displaying images reproduced by a DVD recorder 2 and a hard disk recorder 3, respectively;

FIG. 3 is a diagram showing an manipulation panel of a remote control;

FIG. 4 is a flow diagram showing selection switching control processing performed in a manipulation selection control circuit 6;

FIGS. 5A and 5B are diagrams showing exemplary displays when a selection frame SW bordered along the screen region ER or EL is superimposed within the display screen 10a of the display device 10; and

FIG. 6 is a diagram showing an exemplary display when a selection mark SM is displayed in a peripheral portion of the screen region ER or EL within the display screen 10a of the display device 10.

### DETAILED DESCRIPTION OF THE INVENTION

In the following, one embodiment of the present invention will be described in detail with reference to the drawings.

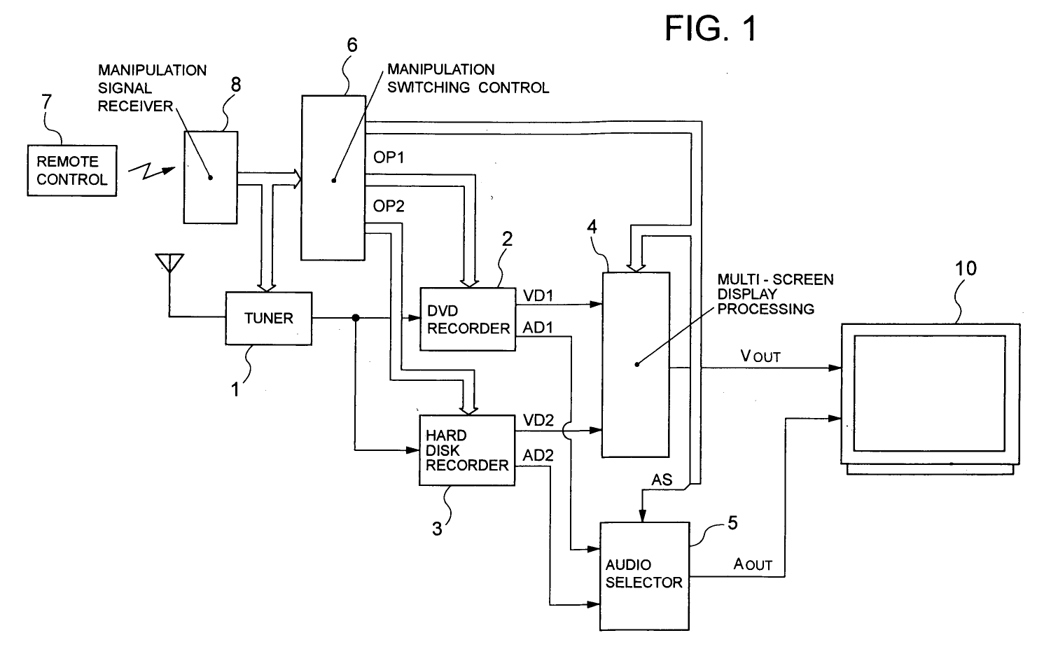

FIG. 1 is a diagram generally showing the configuration of a recording system which is equipped with a control apparatus according to the present invention.

In FIG. 1, a TV tuner 1 receives television broadcast waves supplied through an antenna or a cable, and only selects a broadcast wave from a broadcasting station corresponding to a channel specified by a channel specifying signal CS. The TV tuner 1 demodulates the broadcast wave to generate a received television signal which is supplied to each of a DVD recorder 2 and a hard disk recorder 3.

The DVD recorder 2 records video data and audio data based on the received television signal on a DVD (not shown). The DVD recorder 2 also reproduces video data and audio data recorded on a DVD, supplies the reproduced video data to a multi-screen display processing circuit 4 as video data DV1, and supplies the reproduced audio data to an audio selector 5 as audio data AD1.

The DVD recorder 2 performs an operation indicated by a recording/reproducing operation instruction signal OP1 supplied from a manipulation switching control circuit 6. For example, when the DVD recorder 2 is supplied with the recording/reproducing operation instruction signal OP1 indicative of a recording operation, the DVD recorder 2 starts the recording operation as mentioned above. On the other hand, when the DVD recorder 2 is supplied with the recording/reproducing operation instruction signal OP1 indicative of a reproducing operation, the DVD recorder 2 starts the reproducing operation as mentioned above. Further, when the DVD recorder 2 is supplied with the recording/reproducing operation instruction signal OP1 indicative of a stopping operation, the DVD recorder 2 stops the reproducing operation or recording operation as mentioned above.

The hard disk recorder 3 records the video data and audio data based on the received television signal on a magnetic disk as a built-in recording medium. The hard disk recorder 3 also reproduces video data and audio data recorded on the magnetic disk, supplies the multi-screen display processing circuit 4 with the reproduced video data as video data VD2, and supplies the audio selector 5 with the reproduced audio data as audio data AD2.

The hard disk recorder 3 performs an operation indicated by a recording/reproducing operation instruction signal OP2 supplied from the manipulation switching control circuit 6. For example, when the hard disk recorder 3 is supplied with the recording/reproducing operation instruction signal OP2 indicative of a recording operation, the hard disk recorder 3 starts a recording operation as mentioned above. On the other hand, when the hard disk recorder 3 is supplied with the recording/reproducing operation instruction signal OP2 indicative of a reproducing operation, the hard disk recorder 3 starts a reproducing operation as mentioned above. Also, when the hard disk recorder 3 is supplied with the recording/reproducing operation instruction signal OP2 indicative of a stopping operation, the hard disk recorder 3 stops the reproducing operation or recording operation as mentioned above.

The audio selector 5 selects one indicated by an audio output selection signal AS from the audio data AD1 and AD2, and supplies the display device 10 with an audio signal A_{OUT} corresponding to the selected audio data. In this event, sound corresponding to the audio signal A_{OUT} is output from a speaker (not shown) contained in the display device 10.

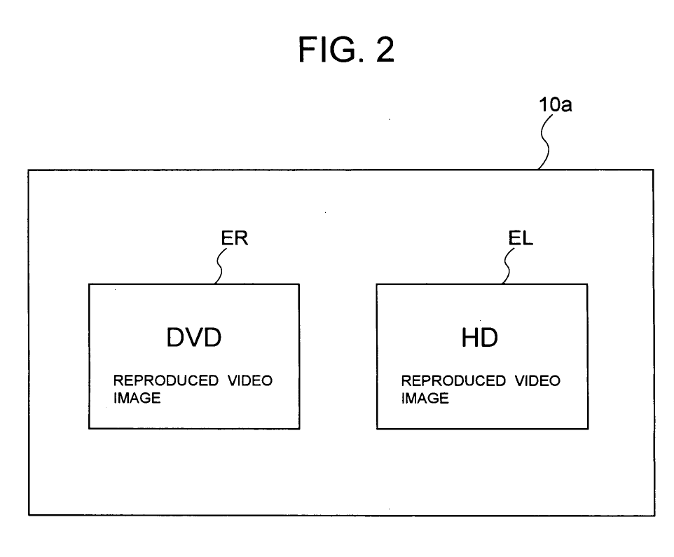

The multi-screen display processing circuit 4 generates a video signal for displaying an image based on the video data VD1 and VD2 on the display device 10 in a display mode specified by a display mode specifying signal MOD, and supplies the display device 10 with this as a video signal V_{OUT}. For example, when the display mode specifying signal MOD indicates a DVD display mode, the multi-screen display processing circuit 4 generates the video signal V_{OUT} for displaying an image based on the video data VD1 over the entire screen of the display device 10. When the display mode specifying signal MOD indicates a HD display mode, the multi-screen display processing circuit 4 generates the video signal V_{OUT} for displaying an image based on the video data VD2 over the entire screen of the display device 10. When the display mode specifying signal MOD indicates a multi-screen display mode, the multi-screen display processing circuit 4 generates a video signal V_{OUT} for displaying the image based on the video data VD1 in a left half of the screen of the display device 10 and the image based on the video data VD2 in a right half of the screen of the display device 10. Therefore, as shown in FIG. 2, a video image reproduced by and output from the DVD recorder 2 is displayed in a left half screen region ER within the display screen 10a of the display device 10, and simultaneously, a video image reproduced by and output from the hard disk recorder 3 is displayed in a right half screen region EL. Also, in response to a selection frame display instruction supplied from the manipulation switching control circuit 6, the multi-screen display processing circuit 4 generates the video signal V_{OUT} which represents a single-color selection frame superimposed on the image around the periphery of a screen region (ER or EL) specified by the selection frame display instruction, as shown in FIG. 2.

The remote control 7 has a variety of manipulation buttons on its manipulation panel for receiving a variety of instructing manipulation from the user.

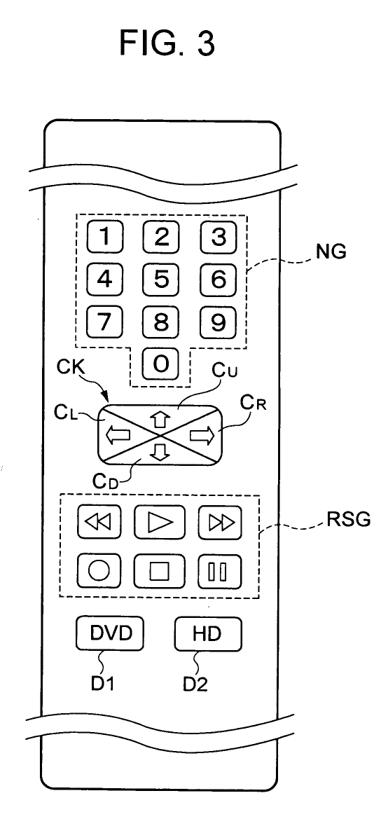

FIG. 3 is a diagram showing a portion of the manipulation panel of the remote control 7.

As shown in FIG. 3, there are provided on the manipulation panel a group of numeral buttons for entering a variety of channels or numerical values for the TV tuner 1 and a cursor key CK for moving a cursor displayed on the screen of the display device 10. The cursor key CK is made up of a right-direction key C_{R} for moving the cursor in the right direction, a left-direction key C_{L} for moving the cursor in the left direction, an upward direction key C_{U} for moving the cursor in the upward direction, and a downward direction key C_{D} for moving the cursor in the downward direction. There is provided on the manipulation panel a group of recording/replay buttons RSG which include a Play button, a Fast Forward button, a Rewind button, a Pause button, a Stop button, a Record button, and the like. Further, there are provided on the manipulation panel a DVD selection button D1 for specifying the DVD recorder 2 as a target for manipulations and a HD selection button D2 for specifying the hard disk recorder 3 as a target for manipulations.

The remote control 7 generates a variety of manipulation signals corresponding to the variety of manipulation buttons depressed by the user for transmission to the manipulation signal receiver circuit 8. The manipulation signal receiver circuit 8 receives the manipulation signals transmitted from the remote control 7, and supplies them to the manipulation switching control circuit 6. Also, when the manipulation signal corresponds to a depression on a button in the group of numerical buttons NG, the manipulation signal receiver circuit 8 supplies the TV tuner 1 with a channel specifying signal CS corresponding to the depressed numeral.

The manipulation switching control circuit 6 is set to a DVD manipulation mode when the manipulation signal includes a signal corresponding to a depression on the DVD selection button D1 on the remote control 7. On the other hand, the manipulation switching control circuit 6 is set to a HD manipulation mode when the manipulation signal includes a signal corresponding to a depression on the HD selection button D2 on the remote control 7. When the manipulation switching control circuit 6 is set to the DVD manipulation mode, the manipulation switching control circuit 6 supplies the DVD recorder 2 with a recorded image reproducing operation instruction signal OP1 corresponding to a depression on a button in the group of the recording/replay buttons RSG on the remote control 7. In this event, the DVD recorder 2 is brought into an operating state specified by the recording/reproducing operation instruction signal OP1. For example, when the user depresses the DVD selection button D1 on the remote control 7 and subsequently depresses the Play button in the recording/replay button group RSG, the DVD recorder 2 within the DVD recorder 2 and hard disk recorder 3 is set into a reproducing operation. On the other hand, when the manipulation switching control circuit 6 is set to a HD manipulation mode, the manipulation switching control circuit 6 supplies the hard disk recorder 3 with a recording/reproducing operation instruction signal OP2 corresponding to the depression on a button in the recording/replay button group RSG on the remote control 7. In this event, the hard disk recorder 3 is set into an operating state specified by the recording/reproducing operation instruction signal OP2. For example, when the user depresses the HD selection button D2 on the remote control 7 and subsequently depresses the Play button in the recording/replay button group RSG, the hard disk recorder 3 within the DVD recorder 2 and hard disk recorder 3 is set into a reproducing operation.

Here, when the DVD recorder 2 and hard disk recorder 3 are both set into the reproducing operation, the manipulation switching control circuit 6 first supplies the multi-screen display processing circuit 4 with a display mode specifying signal MOD which specifies a multi-screen display mode. In response to this display mode specifying signal MOD, the multi-screen display processing circuit 4 supplies the display device 10 with a video signal V_{OUT} for displaying an image based on the video data VD1 on the left half of the screen of the display device 10, and an image based on the video data DV2 on the right half of the screen of the display device 1. In this way, the display device 10 displays the video image reproduced from the DVD recorder 2 within the image region EL in the left half of the display screen 10a. The display device 10 displays the video image reproduced from the hard disk recorder 3 within the screen region ER in the right half of the display screen 10a, as shown in FIG. 2.

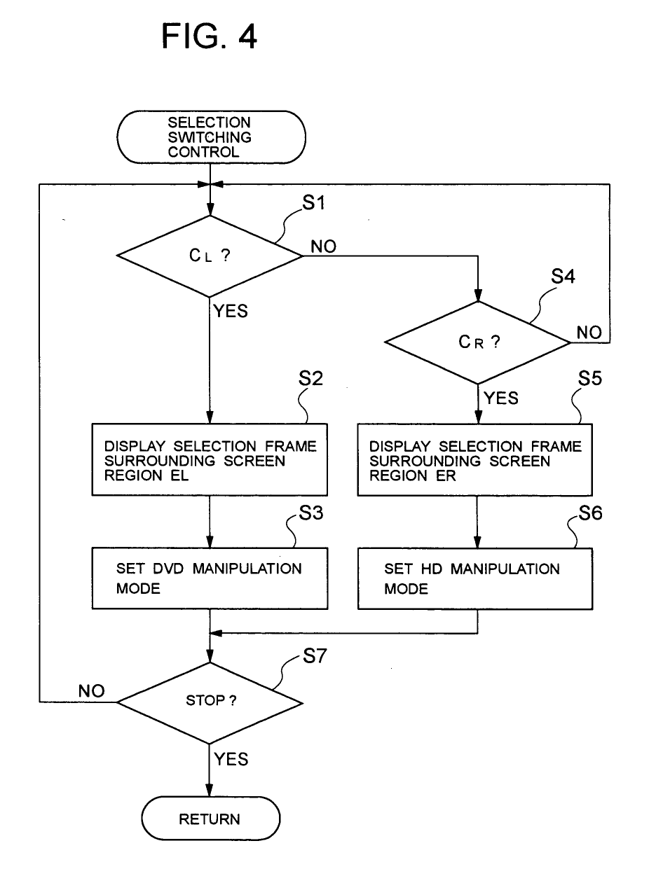

Next, the manipulation switching control circuit 6 executes a control in accordance with a selection switching control flow as shown in FIG. 4.

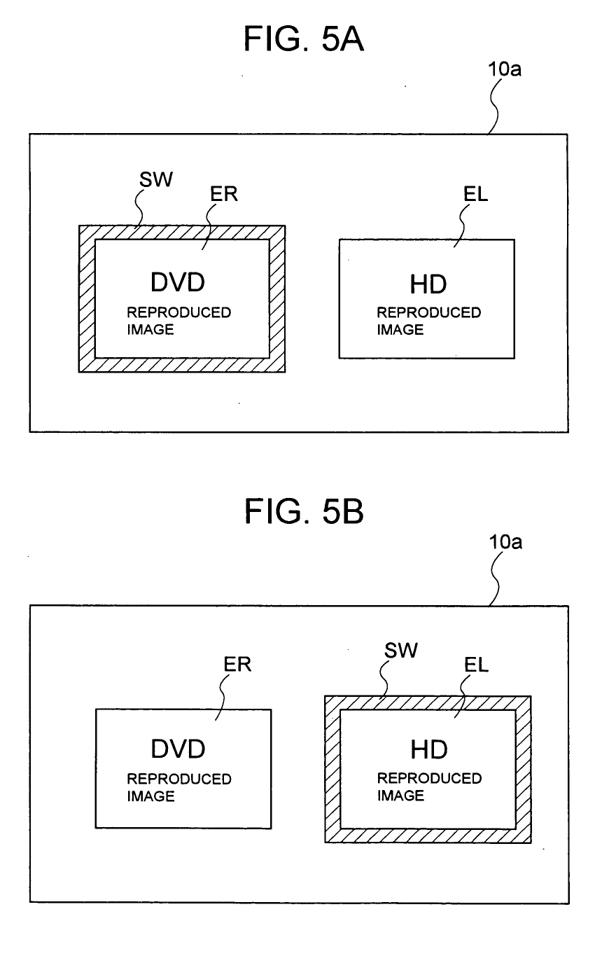

First, in FIG. 4, the manipulation switching control circuit 6 determines whether or not a manipulation signal supplied from the manipulation signal receiver circuit 8 includes a signal corresponding to a depression on the left-direction key C_{L} as shown in FIG. 3 (step S1). If the manipulation signal includes the signal corresponding to a depression on the left-direction key C_{L}, as determined at step S1, the manipulation switching control circuit 6 supplies the multi-screen display processing circuit 4 with a selection frame display instruction for displaying the selection frame which surrounds the screen region EL positioned in the left half of the display screen 10a as shown in FIG. 2 (step S2). A single-color selection frame SW is displayed on the periphery of the screen region EL on the display screen 10a by implementation of step S2, as shown in FIG. 5A. Next, the manipulation switching control circuit 6 stores a DVD manipulation mode flag at logical level 1, indicative of the DVD manipulation mode, in a built-in register (not shown), and supplies the audio selector 5 with an audio output selection signal AS for selecting audio data AD1 (step S3). The execution of step S3 causes the manipulation switching control circuit 6 to enter the DVD manipulation mode, so that the DVD recorder 2 is supplied with a recording/reproducing instruction signal (OP1) corresponding to a variety of recording/reproducing manipulations through the remote control 7. In other words, only the DVD recorder 2 within the DVD recorder 2 and hard disk recorder 3 is subjected to manipulations through the remote control 7. Further, through the execution of step S3, sound based on the audio data AD1 reproduced and output from the DVD recorder 2 is output from the speaker built in the display device 10.

On the other hand, if the manipulation signal does not include a signal corresponding to a depression on the left-direction key C_{L}, as determined at step S1, the manipulation switching control circuit 6 determines whether or not the manipulation signal includes a signal corresponding to a depression on the right-direction key C_{R} as shown in FIG. 3 (step S4). If the manipulation signal does not include a signal corresponding to a depression on the right-direction key C_{R}, as determined at step S4, the manipulation switching control circuit 6 returns to step S1 to repeatedly execute the operation as described above. If the manipulation signal includes a signal corresponding to a depression on the right-direction key CR as determined at step S4, the manipulation switching control circuit 6 supplies the multi-screen display processing circuit 4 with a selection frame display instruction for displaying the selection frame surrounding the screen region ER positioned in the right half of the display screen 10a as shown in FIG. 2 (step S5). The single-color selection frame SW is displayed on the periphery of the screen region ER on the display screen 10a by implementation of step S5, as shown in FIG. 5B. Next, the manipulation switching control circuit 6 stores the HD manipulation mode flag at logical level “1”, indicative of the HD manipulation mode, in the built-in register (not shown), and supplies the audio selector 5 with the audio output selection signal AS for selecting the audio data AD2 (step S6). The execution of step S6 causes the manipulation switching control circuit 6 to enter the HD manipulation mode, so that the hard disk recorder 3 is supplied with a recording/reproducing instruction signal (OP2) corresponding to a variety of recording/reproducing manipulations through the remote control 7. In other words, only the hard disk recorder 3 within the DVD recorder 2 and hard disk recorder 3 is subjected to manipulations through the remote control 7. Further, through the execution of step S6, sound based on the audio signal AD2 reproduced from the hard disk recorder 3 is output from the speaker built in the display device 1.

After the execution of step S3 or S6, the manipulation switching control circuit 6 determines whether or not the manipulation signal supplied from the manipulation signal receiver circuit 8 includes a signal corresponding to a depression on the Stop button in the recording/replay button group RSG as shown in FIG. 3 (step S7). If the manipulation signal does not includes a signal corresponding to a depression on the Stop button as determined at step S7, the manipulation switching control circuit 6 returns to step S1 to repeatedly execute the operation as described above. On the other hand, if the manipulation signal includes a signal corresponding to a depression on the Stop button, as determined at step S7, the manipulation switching control circuit 6 exits the selection switching control flow as shown in FIG. 4, and proceeds to the execution of a main control routine (not shown).

With the configuration as described above, the user can just select one of the screen regions ER and EL displayed within the display screen 10a with the right-direction key CR or the left-direction key CL on the remote control 7 to set an image information reproducing apparatus (DVD recorder 2 or hard disk recorder 3), which is supplying an image displayed in the selected screen region, as a target for the operation control.

Thus, the user can correctly manipulate an image information reproducing apparatus which is supplying a desired image even without recognizing a correspondence relationship between a plurality of images displayed on the screen and respective image information reproducing apparatuses which are supplying these images.

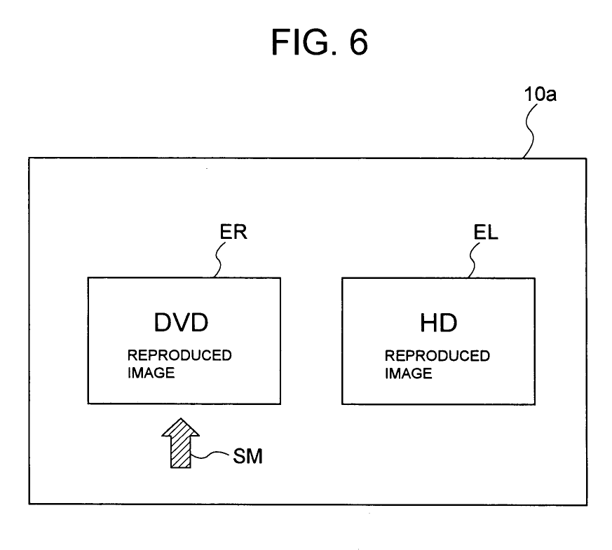

In the foregoing embodiment, the frame-shaped selection frame SW is displayed around the periphery of a selected one of the screen regions ER and EL to visually inform the selected screen region. The shape of the selection frame SW, however, is not limited to that shown in FIG. 5A or 5B. For example, a selection mark SM may be displayed in a peripheral portion of a selected screen region as shown in FIG. 6. In essence, an informing image is only required to be displayed in a peripheral portion of a selected screen region for visually informing the selected screen region.

Also, while in the foregoing embodiment, the screen regions (ER, EL) are switched through a depression on the left-direction key C_{L} and right-direction key C_{R}, the remote control 7 may be provided with a single screen switching button, such that a selected screen region is switched from one to the other each time the screen switching button is depressed.

Also, while in the foregoing embodiment, the selection frame SW is displayed at all times as an informing image around the periphery of a selected screen region, the selection frame SW may be erased by the user through a manipulation on the remote control 7. For example, an instruction for erasing the display of the selection frame SW may be transmitted in response to simultaneous depressions on the DVD selection button D1 and HD selection button D2 provided on the remote control 7. In this event, the multi-screen display processing circuit 4 erases the selection frame SW in response to the display erase instruction.

Also, while the foregoing embodiment has been described in connection with two image information reproducing apparatuses, i.e., the DVD recorder 2 and hard disk recorder 3 for simultaneously reproducing images, such image information reproducing apparatuses may be three or more.

In essence, respective images reproduced by N (N is a natural number equal to or larger than two) image information reproducing apparatuses may be simultaneously displayed in N screen regions, one by one, within a display screen, such that the user is allowed to manipulate only an image information reproducing apparatus which is the source of an image displayed in a screen region selected through a manipulation on the remote controller. This application is based on a Japanese patent application No. 2003-157607 which is hereby incorporated by reference.

1. A control apparatus for controlling a plurality of image information reproducing apparatuses, comprising:
a display controller for simultaneously displaying a plurality of reproduced images on a display screen in accordance with image data reproduced from each of said image information reproducing apparatuses; and
an operation unit for alternatively selecting an operation control common to said image information reproducing apparatuses,
wherein said operation unit selects one of said image information reproducing apparatuses corresponding to a reproduced image arbitrarily selected from the reproduced images displayed on said display screen.

2. A control apparatus for image information reproducing apparatuses according to claim 1, wherein said display controller superimposes an informing image around the periphery of the selected reproduced image, said informing image informing that the reproduced image is selected as a target for said operation control.

3. A control apparatus for image information reproducing apparatuses according to claim 2, wherein said informing image has a frame-shape.

4. A control apparatus for image information reproducing apparatuses according to claim 2, wherein said informing image is of a single-color.

5. A control apparatus for image information reproducing apparatuses according to claim 2, wherein said informing image has a single-colored frame-shape.

6. A control apparatus for image information reproducing apparatuses according to claim 2, wherein said display controller stops displaying the informing image in response to an informing image display stop instruction.

7. A control apparatus for image information reproducing apparatuses according to claim 1, wherein at least one of said image information reproducing apparatuses is a recording medium driving device for reproducing recorded information from a recording medium which has image information recorded thereon.

8. A control apparatus for image information reproducing apparatuses according to claim 7, wherein at least one of said image information reproducing apparatuses is an optical disk recorder or a magnetic disk recorder.

9. A control method for controlling a plurality of image information reproducing apparatuses by using an operation unit for alternatively performing an operation control common to said image information reproducing apparatuses, comprising:
displaying a plurality of reproduced images simultaneously on a display screen in accordance with image data reproduced from each of said image information reproducing apparatuses; and
selecting one of said image information reproducing apparatuses corresponding to a reproduced image arbitrarily selected from the reproduced images displayed on said display screen as a target for the operation control by using said operation unit.
